(19) United States
(12) Patent Application Publication
(10) Pub. No.: US 2025/0190786 A1
(43) Pub. Date: Jun. 12, 2025

(54) Simulating a Conversation

(71) Applicant: Siemens Aktiengesellschaft, München (DE)

(72) Inventors: Martin Kramer, Gauting (DE); Tobias Aigner, München (DE)

(73) Assignee: Siemens Aktiengesellschaft, München (DE)

(21) Appl. No.: 18/842,332

(22) PCT Filed: Jun. 27, 2023
(86) PCT No.: PCT/EP2023/067361

§ 371 Date: Aug. 28, 2024

(30) Foreign Application Priority Data
Jun. 30, 2022 (DE) 10 2022 206 664.2

(51) Int. Cl. G06N 3/08

(52) U.S. Cl. CPC G06N 3/08

(57) ABSTRACT

Various embodiments include a method for simulating a conversation using an electronic computing device with an input device, an output device, a simulation controller, and a number of virtual participants. An example includes: providing each virtual participant content from user text or generated text input; producing a response using AI; selecting a participant to forward the user input in text form; analyzing the user input with a text analyzer of the selected virtual participant; transmitting the data of the analysis to a neural network with an AI; working out a reaction with the AI; transmitting the reaction to a text generator of the selected virtual participant; distributing the reaction in text form as a response to the simulation controller; and selecting a further participant with the simulation controller to continue the simulation.

### CROSS-REFERENCE TO RELATED APPLICATIONS

This application is a U.S. National Stage Application of International Application No. PCT/EP2023/067361 filed Jun. 27, 2023, which designates the United States of America, and claims priority to DE Application No. 10 2022 206 664.2 filed Jun. 30, 2022, the contents of which are hereby incorporated by reference in their entirety.

### TECHNICAL FIELD

The present disclosure relates to simulating a conversation. Various embodiments of the teachings herein include simulations using an electronic computing device, the conversation being such as takes place for example in connection with the discussion of complex technical problems.

### BACKGROUND

It is already known that conversations on whatever topics, but in particular also for discussing technically complex problems, may be greatly dependent on person-specific factors. For example, the prior knowledge of the individual participants and their mood and personal condition always also play a crucial part in whether or not the conversation proceeds in a focused and purposeful way.

There are theories and models which increase the quality of conversations, in particular those for finding new ideas or solutions for complex technical problems. For example, there is de Bono's so-called “Six Thinking Hats”, a creativity technique which deals with linked parallel thinking as a tool for group discussions. Moreover, there is the TRIZ theory for solving inventive problems, which is based on abstracting concrete problems until they are subsumable under a general problem for which there is a general solution. Finally, there are techniques, such as “brainstorming” and “mind mapping”, which do not stipulate a structure, but rather simply gather ideas and attempt to establish connections. The personal factors and the dynamics of a conversation are and remain unpredictable, however, and are often not only ineffective but also counterproductive.

### SUMMARY

Teachings of the present disclosure include methods, computer program products, computer-readable storage media, and electronic computing devices by means of which a conversation is simulated. For example, some embodiments include a method for simulating a conversation by means of an electronic computing device (10) with at least one input and output device (26, 28), a simulation controller (22) and a number of virtual participants (20), wherein each virtual participant (20), by means of the electronic computing device (10), by way of a text analyzer (18), can acquire the content of the user text input (30, 26) or of the generated text input of a virtual participant (20), produces a response thereto by means of an artificial intelligence “AI” and passes it back to the simulation controller (22) in such a way that a user (30) stipulates a topic for the simulation controller (22) by means of an input device (26), wherein: a) at the start of the simulation, the simulation controller (22) selects a participant (20) to which it forwards the user input—or the most recent response of the last participant (20) in text form, b) the text analyzer (18) of the selected virtual participant (20) analyzes the content, c) the data of the analysis are transmitted to a neural network with an AI, d) the AI works out one or more reactions and/or response(s) and e) provides same to the text generator (16) of this virtual participant (20), f) wherein the text generator (16) of the selected virtual participant (20) outputs same in text form as response(s) to the simulation controller (22), and g) the simulation controller (22) then again selects a further participant (20) in order to forward to the latter the response in text form and thus to continue the simulation with the same method steps a) to g).

In some embodiments, simulation monitoring (24) is carried out.

In some embodiments, the simulation monitoring (24) is carried out by way of the output device (28) and/or feedback by the human user (30).

In some embodiments, automated simulation monitoring (24) is carried out by the electronic computing device.

In some embodiments, the data of the simulation monitoring (24) and/or of the feedback by the human user (30) are stored in a discussion memory (34).

In some embodiments, the data from the discussion memory (34) are used as training data for the AI.

In some embodiments, the selection of a virtual participant (20) by the simulation controller (22) is effected randomly.

In some embodiments, the participant configuration (14, 36) is effected at least partly on the basis of de Bono's theory.

In some embodiments, the participant configuration (14, 36) is effected at least partly on the basis of the TRIZ theory.

In some embodiments, the method is effected as part of an interactive method for carrying out a discussion via the at least one input and output device (26, 28).

In some embodiments, the text generator (16) comprises a language model.

In some embodiments, the text generator (16) is designed and/or configured such that GPT-3 is used.

As another example, some embodiments include a computer program product having program code means which cause an electronic computing device (10), when the program code means are processed by the electronic computing device (10), to carry out one or more of the methods as described herein.

As another example, some embodiments include a computer-readable storage medium having a computer program product as described herein.

As another example, some embodiments include an electronic computing device (10) for simulating a conversation on a predefined topic having at least one simulation controller (22), two or more virtual participants (20), each of which comprises a text analyzer (18) and a text generator (16), wherein the electronic computing device (10) is designed for carrying out one or more of the methods described herein.

### BRIEF DESCRIPTION OF THE DRAWINGS

The figures hereinafter show schematic block diagrams of two example embodiments of an electronic computing device incorporating teachings of the present disclosure. In the figures, identical or functionally identical elements are provided with the same reference signs.

FIG. 1 shows a schematic block diagram of an example electronic computing device.

FIG. 2 shows an example electronic computing device.

### DETAILED DESCRIPTION

Some embodiments of the teachings herein include methods for simulating a conversation by means of an electronic computing device with at least one input and output device, a simulation controller and a number of virtual participants, wherein each virtual participant, by means of the electronic computing device, by way of a text analyzer, can acquire the content of the user text input or of the generated text input of a virtual participant, produces a response thereto by means of an artificial intelligence “AI” and passes it back to the simulation controller in such a way that a user stipulates a topic for the simulation controller by means of an input device, wherein
a) at the start of the simulation, the simulation controller selects a participant to which it forwards the user text input—or the most recent response of the last participant in text form,
b) the text analyzer of the selected virtual participant analyzes the content,
c) the data of the analysis are transmitted to a neural network with an AI,
d) the AI works out one or more reactions and/or response(s) and
e) provides same to the text generator of this virtual participant,
f) wherein the text generator of the selected virtual participant outputs same in text form as response(s) to the simulation controller, and
g) the simulation controller then again selects a further participant in order to forward to the latter the response in text form and thus to continue the simulation with the same method steps a) to g).

In some embodiments, the monitoring of the simulation can be effected by a human user by way of the output device and/or alternatively in an automated manner by means of the electronic computing device.

In some embodiments, by way of the interposed AI, the method may have recourse to a wide variety of data sources, for example the IoT or else a discussion memory in which data regarding past conversations, in particular also on the topic, are retrievable, and can thus simulate discussions which offer new ideas as the end result.

In some embodiments, the method also comprises a method step of automated simulation observation, in which the behavior of the configured system is observed by a module of the electronic computing device. If the observation or monitoring of the simulation is effected in an automated manner, then the data from the monitoring are stored in a discussion memory and/or are available as training data to the artificial intelligence of the system with the electronic computing device.

Some embodiments include a method for simulating conversations which combines text generating models from the artificial intelligence with simulation methods. The system can be configured with various properties and participants. Each participant can be configured such that it has different properties and behaviors. The simulation can be configured such that it proceeds without human interaction. However, it can also be configured such that the simulation is interrupted and waits for human inputs before it is continued. In this way, the human user can control the conversation and steer the simulation in specific directions.

The teachings may be used for example in at least the following cases:
Simulation of discussions for generating new ideas.
Simulation and observation of the behavior of systems with participants having different properties, e.g. participants that draft negative or skeptical texts, participants with a varying rate of participation in conversations, fundamentally technocratically minded and fundamentally emotionally minded participants, and much more.
Generation of ideas for solving problems.
Creation of training data sets for the fine-tuning of conversation text models.
Creation of verification and validation data sets for interactive systems.
Acquisition of basic data regarding human behavior in the context of a discussion.

In some embodiments, the properties of the virtual participants are varied. In some embodiments, each virtual participant can be configured with various properties and/or behaviors. In this case, for example, de Bono's 6 hats can be reproduced virtually. For example, the system comprises 6 virtual participants and each represents a thinking hat according to de Bono, i.e.
one virtual participant represents ordering, moderating thinking of the overview of processes,
a further virtual participant represents analytical thinking with associated facts,
a further virtual participant introduces thinking with feelings and opinions,
a further virtual participant represents critical scrutiny, reservations, problems, skepticism, and fears, and in opposition to this participant there is for example
a further virtual participant specializing in best case scenarios, and
finally, one virtual participant can be configured such that it represents divergent, creative, lateral thinking.

Each response of an opponent can then be produced by strategic simulation control.

In some embodiments, the simulation observation makes it possible to categorize the responses of the virtual participants according to various aspects, for example length of the text, according to linguistic analysis, i.e. e.g. negative, positive, ironic or skeptical language, according to repetitions and/or obvious gaps.

Simulation is used in many fields. It makes it possible to simulate and/or vary the result with different input parameters and to compare the results in each case. However, it also makes it possible to observe the behavior of the simulated system. The parameters, having been only slightly changed, can be subjected to a further simulation and the result can be compared after the modification of the configurations. In this case, the simulation observation generates further data, which in turn can again be made available to the electronic computing device by way of the AI used by each virtual participant.

By means of this method, during a negotiation, too, one or more strands of argument can first of all be thoroughly discussed virtually and the result of the virtual detailed conversation can be made available again to the negotiating parties. Moreover, the linguistic analysis can draw attention to repetitions in an ongoing conversation.

The present teachings combine the approaches of simulation, text generation, and text analysis. For example, what is still a weak point of text or linguistic analysis and text or speech generation is that it is not possible to differentiate between right or wrong, irony or seriousness. However, if the text analysis and text generation are combined with a simulation, as proposed for the first time by the present method, then from the reactions of the other virtual participants it is possible to tell what one is dealing with and irony becomes recognizable by way of speech generation after simulation has been carried out.

With more powerful models, the text generating abilities of language models are improving, see GPT-3. These models have been trained with large amounts of text data. The models can be used generically without further training. However, the pretrained models can also be optimized for specific tasks. For example, GPT-3 is a so-called autoregressive transformer model that was trained with enormous amounts of data. When GPT-3 was launched, it was stated that this API programming interface has a universal “text-in, text-out” interface which can accomplish almost “any English-language task”, instead of the usual single application. Various embodiments use this interface for—in some cases, taking place in real time-correction, adaptation and changing of the rules and/or the configuration during the method for simulation.

By virtue of the possibility of changing the rules and sequences of the simulation during the method and/or adapting them to the results of the simulation, this method uses the most recent techniques possible for producing freely adaptable simulations—in real time, during an ongoing negotiation. In some embodiments, there is the possibility of rewinding the simulation to a point x, which can be defined temporally or in some other way, and, with an adapted configuration, of producing and/or testing a new simulation from this point. For this purpose, the system for carrying out the method has a so-called discussion memory.

GPT-3 is part of a trend in systems for natural language processing (NLP) in which language representations are pretrained. The quality of the text produced by GPT-3 is so high that it can be difficult to ascertain whether or not it was written by a human.

In some embodiments, an electronic computing device comprises for example processors, circuits, in particular integrated circuits, and further electronic components in order to be to carry out one or more of the methods described herein.

Advantageous embodiments of the method should be regarded as advantageous embodiments of the computer program product, the computer-readable storage medium and the electronic computing device. The electronic computing device has in particular corresponding features in order to be able to carry out the method. For applications and/or application situations which may arise in the method and which are not explicitly described here, it may be provided that, in accordance with the method, an error message and/or a request for user feedback to be input are/is output and/or a standard setting and/or a predetermined initial state are/is set.

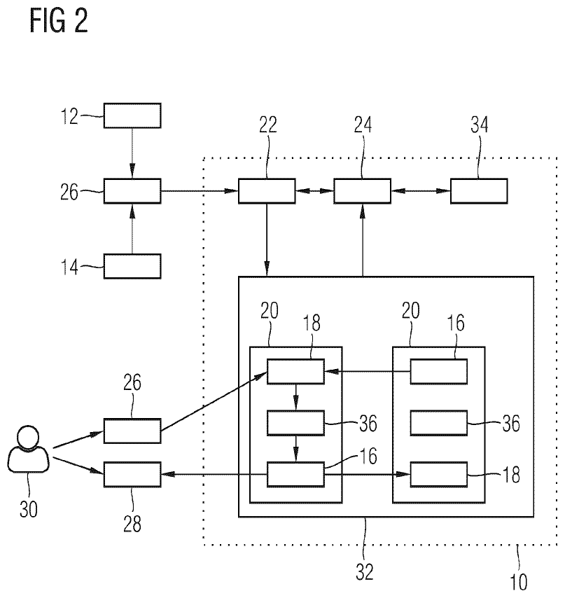

Further modules of the electronic computing device can comprise elements such as loudspeakers and/or microphones. These modules have for example one or more interfaces (e.g. database interfaces, communication interfaces—e.g. network interface, WLAN interface) and/or one or more evaluation unit(s) (e.g. a further processor) and/or one or more storage unit(s), such as the discussion memory 34 from FIG. 2.

By means of the interfaces, for example, data can be exchanged (e.g. received, communicated, transmitted or provided). By means of the evaluation unit, data can be compared, checked, processed, assigned or calculated for example in a computer-aided and/or automated manner. By means of the storage unit, data can be stored, retrieved or provided for example in a computer-aided and/or automated manner.

An “electronic computing device” is understood to mean a device having at least one processor and/or a neural network. In association with the invention, a “processor” can be understood to mean a machine and/or an electronic circuit, for example. A processor can be, in particular, a central processing unit (CPU), a microprocessor or a microcontroller, for example an application-specific integrated circuit or a digital signal processor, possibly in combination with a neural network and/or a storage unit for storing program instructions, etc. A processor can for example also be an IC (integrated circuit), in particular an FPGA (field programmable gate array) or an ASIC (application-specific integrated circuit), or a DSP (digital signal processor) or a graphics processing unit (GPU).

Moreover, a processor can mean a virtualized processor, a virtual machine or a soft CPU. It can for example also be a programmable processor which is equipped with configuration steps for carrying out the stated method or is configured with configuration steps in such a way that the programmable processor realizes the features according to the methods or of the modules, or of other aspects and/or partial aspects of the teachings herein.

In some embodiments, the electronic computing unit comprises the following modules:
Simulation controller with a simulation configuration defining e.g. the number of simulations, number of virtual participants, number of iterations and/or the kind of simulation monitoring. The possibility of checking—in particular also feedback in the form of an additional input by a human user, etc.—is also defined there. If it is envisaged that a user observes the simulation during the latter and wants to modify the direction taken, then provision can advantageously be made for the ongoing simulation to be stopped and “corrected” by the user during this simulation.
The simulation controller uses the simulation configuration and coordinates the simulation. The simulation controller selects which virtual participant is used for the simulation. The simulation controller records a progression of the simulation, which is passed back to the user when the simulation has ended. In addition, according to one advantageous embodiment, the simulation controller also records statistics about the participants. In some embodiments, these data are stored in a discussion memory and optionally made available to a virtual participant as training data.
Virtual participants with participant configuration. Each virtual participant participates in the simulation if the simulation controller randomly or strategically selects this participant. It uses a text generator and a text analyzer in order to generate a response in the form of a new text input. The virtual participant selected verifies that the text generated by it corresponds to the configuration. If the generated text does not fulfil the configuration, a further text is generated. The newly generated text is once again verified. This is repeated by way of iteration loops until the virtual participant classifies the generated text as configured.
In the participant configuration, the properties of a virtual participant are configured, for example attributes about the participant itself, for example the fact that it is a strategic thinker that always seeks basic principles—in a manner comparable to the TRIZ theory—and attributes about its behavior in the simulation, such as e.g. the probability of the virtual participant contributing to the simulation without being asked.
Text generator, this module receives text inputs and, on the basis thereof, generates a response of the form of a new text input; the original text input here may also originate from a human user, e.g. at the start of the simulation, or it originates from another virtual participant in the course of the simulation.
The text generator module uses at least one language model, for example GPT-3. In some embodiments, a language model is used in which the generated text is controllable, in particular with regard to the topic, the subjects dealt with and/or the tone or courteousness of expression.
In some embodiments, the language model(s) is/are pretrained and/or coordinated in relation to specific data or areas, in particular topic areas. With the aid of fine tuning, a model can be trained in order e.g. to generate mostly positive-sounding text and/or with a specific language associated more or less evidently with a specific area of knowledge.
Text analyzer, a module which analyzes and classifies the text generated or input. In some embodiments, the text analyzer can recognize whether the text generated has a skeptical, positive or negative slant. Moreover, the properties of the configuration can be checked by way of the text analysis of the text input.
Module for simulation monitoring, which monitors, observes and assesses the progression of the simulation. Primarily also the results of the simulation in respect of their contact with reality or lack of contact with reality. This role can be performed e.g.—depending on the embodiment-wholly or partly by the human user. This feedback gives the system the opportunity to learn which context-specific reactions lead to creative and purposeful contributions, for example in the form of discussion context, participant attitude in the discussion context or similar participant-specific configurations. However, the simulation monitoring can also be effected by machine, which possibly involves a method step of calculation regarding the probability of the realization of an idea generated as the result of the simulation.

In some embodiments, the electronic computing device comprises at least one or more processors, and one or more neural networks, one or more storage units, and voice input and voice output devices, interconnected to form a system configured suitably for carrying out the method.

The advantages of the various embodiments disclosed here may include:
Production of ideas generated entirely by software—also as a basis of human discussions concerning a problem.
Problem-solving simulations for generating new ideas.
Observation of the behavior of systems with different configurations. The conversation can be observed with varying participant behavior, e.g. small number of participants talk more than others or predominantly skeptical participants.
The simulation observation by humans during the simulation in order to control the simulation and to give the simulation additional information or feedback.
The system can learn from human examples in order to further improve the generated conversation and its own behavior in the conversation and, conversely, the system can be used for training humans.
The simulation can produce data sets for the training of language models.
The system can learn by collecting user feedback in the observer role.

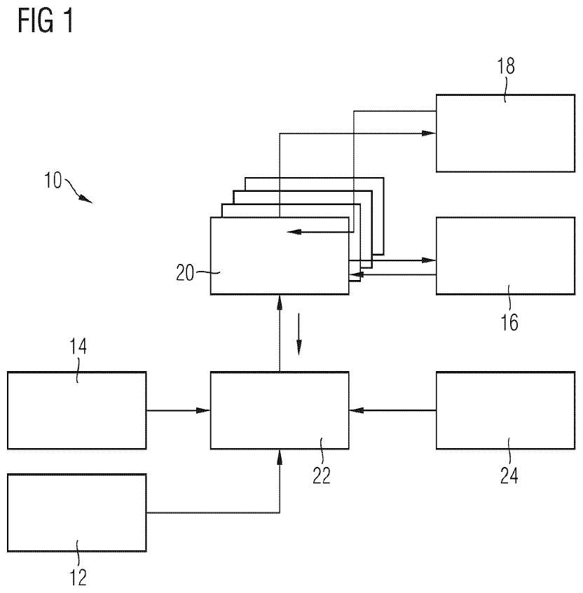

FIG. 1 shows a schematic block diagram of an example electronic computing device 10 incorporating teachings of the present disclosure. The central module is the simulation controller 22, which is correspondingly arranged centrally. The configurations, firstly the simulation configuration 12 and secondly the participant configuration 14, are prescribed for this simulation controller. By means of these configurations, the simulation controller 22 selects from the pool of virtual participants 20 a participant 20 to which the input of the user is presented as input. By means of a text analyzer and a text generator, the selected virtual participant generates a new text input, which is passed from the virtual participant 20 to the simulation controller 22.

In some embodiments, these new text inputs are observed by simulation monitoring 24. The latter can be effected both by a human user and by machine. In any case the simulation monitoring 24 has the option to intervene in the simulation at any time. The simulation procedure then stops-so-called “pause function”—and the currently available text is fed into the ongoing simulation again after having been altered by supplementation, deletion, correction.

Besides the pause function, there may be a “rewind function”, that is to say that the method is manually or automatically returned to a selected point
temporally,
in terms of the configuration,
in terms of the participant composition
in terms of the text
in terms of the mood
according to any parameter or definable and stipulated point acquired by the system.
From this point, the simulation restarts one or more times and the result of the new simulation can then be compared with that of the simulation produced originally. It is possible to select various points in this regard, restarts of the simulation being effected for each of these points.

During execution, each input of a user is instigated, by human or artificially, automatically or in a targeted manner, and is recorded and stored or temporarily stored by a log.

The term inputs denotes in that respect firstly voice inputs in the sense of utterances which are able to be read out as text by way of voice recognition. In some embodiments, inputs which are obtainable by way of audio and/or visual methods for recognizing user emotions can also be regarded as inputs. These comprise for example utterances that are included in the method by virtue of content, connotation, emotional slant, pause placement, and/or intonation of the participants. Moreover, automatically acquirable data such as data regarding face recognition, gestures, physiological data of the participants that are acquirable by way of sensors and/or a camera, such as blood pressure, heart rate, facial expressions, pitch of the speech, are also fed into the system as inputs.

In addition, there are emotionally less fully recognizable inputs such as text inputs by way of a keyboard, mouse clicks. These inputs each lead to a change of discussion content and give rise to an entry in a separate storage unit. This storage unit is thereby constantly updated, which corresponds to logging this may be stored separately in a retrievable manner, in a storage unit that is referred to e.g. as discussion memory, and is retrievable there according to various aspects, in terms of content, thematically, temporally, in relation to participants, etc.

An entry in the discussion memory is able-depending on predefinition and design of the processor—to bring about a change in the configuration, e.g.
the number of participants is adapted, i.e. increased or decreased,
the composition of the discussion participants is altered, i.e. some are “muted”, inactive participants are activated again, new participants with new features, authorizations and/or knowledge are included or excluded and/or
modes of the participants are altered, e.g. conservative mode changed to progressive mode, indifferent mode changed to empathetically active mode, defensive discussion behavior changed to aggressive discussion behavior.

These changes in the configuration can be altered for example on the basis of one or more inputs. This/these change(s) in the configuration can be effected subsequently, during rewinding, i.e. still during the discussion, or in real time.

The simulation monitoring can pause the discussion at any time and permit the current discussion state to persist by way of the logging of the discussion memory and can reestablish an arbitrary previous state and continue the simulation anew from that point-so-called iteration loop. In addition, the participant configuration and number can be altered in a paused state. Furthermore, the discussion content can also be altered by insertions, deletions or corrections. These pausing and continuation operations give rise, in the discussion memory, to a tree-type storage structure of different strands of discussion, which can optionally also be simulated in parallel.

The recordings from the simulation monitoring 24 can be transferred to a discussion memory (not shown here) in order that they are usable e.g. as training data.

During execution, firstly the user configures the simulation configuration and the participant configuration. The simulation configuration involves configuring for example the number of iteration loops or the discussion duration (as termination condition), the number of participants, the selection of the participants, whether randomly or strategically, etc. The participant configuration involves configuring the properties thereof. In this case, depending on the topic, for example in the case of a technical problem, a skeptic expecting material defects, etc. should be countered by an activist who proposes quick shortening of a synthesis route by replacing a boiler with a pipe, etc., without completely mentioning the safety risks.

As a further property, for example, a virtual participant that always sees the economic outcomes, i.e. turnover, profit, etc., can be countered by a further virtual participant that is programmed so as essentially to put forward arguments in relation to sustainability and ecological balance.

At the beginning, a text input is effected in the electronic computing device 10, which starts the simulation. The simulation controller 22 thereupon starts the configured number of virtual participants 20. The simulation controller 22 selects, for example randomly, a virtual participant 22 to which it makes the text input available. The selected participant 22 receives the data that have been input and uses the text generator to create a text. By means of the text analyzer, said participant analyzes the generated text to establish whether it corresponds to the configuration. This is repeated until the generated text corresponds to the configuration.

The simulation controller uses the generated text and selects a further, optionally random, participant 20 in order to continue the simulation. The simulation controller 22 for example also takes into account the configured threshold value of the participant 20 in respect of how often the latter contributes to the simulation. The simulation monitoring 24 observes the results of the simulation.

This is repeated until the number of configured simulations is concluded. The history of the generated simulations is stored in the discussion memory 34 (shown in FIG. 2). In addition, for example, statistics about the interactions between the participants 20 are stored.

The system has a clock and keeps a log of the utterances of the discussion participants. Each entry in this log reveals when it was uttered and by which participant, and optionally also in response to which prior utterance it makes reference. By way of example, an assignment as to which utterance of which participant occurred with which configuration—as input—occurs in the log.

At any arbitrary time, the simulation controller can mute participants or remove them from the conversation—that is all recorded in the log and is stored e.g. as “participant configuration” in the discussion memory.

This may be relevant in particular with regard to the selection of a suitable point for the return of the simulation to this point as “selected point”.

By creating multiple instances, it is possible for this system to be scaled across the hardware and used for carrying out ensemble passes, thereby eliminating the described loading as a result of the serialization.

In some embodiments, the system can be configured such that specific words or topics are used with higher probability.

In some embodiments, the user can observe the system during the simulation and control the simulation. These inputs are used by the system in order to learn from the user and are used for the later simulations.

In some embodiments, the structure of the conversation can be configured, e.g. a specific number of messages concerning the finding of ideas, followed by the discussion of specific topics.

FIG. 2 shows an example electronic computing device 10 incorporating teachings of the present disclosure and comprising the following modules: a simulation controller 22, simulation monitoring 24 and a discussion memory 34. A discussion simulation module comprising two virtual participants 20 is present in a manner communicatively coupled to the simulation controller. Each of said virtual participants has a central controller 36, which is communicatively coupled to a text analyzer 18 on one side and to a text generator 16 on the other side.

By way of an input device 26, a human user 30 can feed a simulation configuration 12 and the participant configuration 14 and also feedback concerning the results and/or interim results of the simulation observation 24 to the system. The user 30 can find out the simulation observation 24 and also the result of the simulation by way of an output device 28.

Various embodiments of the teachings herein include a method for simulating a conversation using a text analyzer and a text generator. The combination of the two approaches with simulation configuration and participant configuration makes it possible not only to simulate discussions among participants but also to observe the behavior of the configured system and to make the data from this observation usable.

### LIST OF REFERENCE SIGNS

10 Electronic computing device
12 Simulation configuration
14 Participant configuration
16 Text generator
18 Text analyzer
20 Participant agent
22 Simulation controller
24 Simulation monitoring
26 Input device
28 Output device
30 Human participant
32 Discussion simulation
34 Discussion memory
36 Agent state and controller

What is claimed is:

1. A method for simulating a conversation using an electronic computing device with an input device, an output device, a simulation controller, and a number of virtual participants, the method comprising:
providing each virtual participant using a text analyzer of the electronic device, content from user text or generated text input of a virtual participant;
producing a response thereto sing an artificial intelligence (AI); and
returning the response to the simulation controller so a user stipulates a topic for the simulation controller using the input device;
selecting a participant at start of the simulation to forward the user input in text form;
analyzing the user input with a text analyzer of the selected virtual participant;
transmitting the data of the analysis to a neural network with an AI;
working out a reaction with the AI;
transmitting the reaction to a text generator of the selected virtual participant;
distributing the reaction in text form as a response to the simulation controller; and
selecting further participant with the simulation controller to continue the simulation.

2. The method as claimed in claim 1, further comprising monitoring the simulation.

3. The method as claimed in claim 2, wherein the output device carries out the simulation monitoring and monitors feedback by the human user.

4. The method as claimed in claim 1, further comprising monitoring the simulation with the electronic computing device.

5. The method as claimed in claim 2, further comprising storing data generated by simulation monitoring and/or feedback from the human user in a discussion memory.

6. The method as claimed in claim 5, further comprising using the data from the discussion memory as training data for the AI.

7. The method as claimed in claim 1, wherein selection of a virtual participant by the simulation controller is random.

8. The method as claimed in claim 1, wherein the participant configuration is effected at least partly on the basis of de Bono's theory.

9. The method as claimed in claim 1, wherein the participant configuration is effected at least partly on the basis of the TRIZ theory.

10. The method as claimed in claim 1, which is effected as part of an interactive method for carrying out a discussion via the input device and the output device.

11. The method as claimed in claim 1, wherein the text generator comprises a language model.

12. The method as claimed in claim 1, wherein the text generator uses GPT-3.

13-14. (canceled)

15. An electronic computing device for simulating a conversation on a predefined topic, the device comprising:
a simulation controller;
two virtual participants each having a text analyzer and a text generator;
wherein the simulation controller to:
provide each virtual participant, using text analyzer of the electronic device, content from user text or generated text input of a virtual participant;
produce a response thereto using an artificial intelligence (AI); and
return the response to the simulation controller so a user stipulates a topic for the simulation controller using the input device;
select a participant at the start of the simulation to forward the user input in text form;
analyze the user input with a text analyzer of the selected virtual participant;
transmit the data of the analysis to a neural network with an AI;
work out a reaction with the AI;
transmit the reaction to a text generator of the selected virtual participant;
distribute the reaction in text form as a response to the simulation controller; and
select a further participant with the simulation controller to continue the simulation.
